(19) United States
(12) Patent Application Publication
(10) Pub. No.: US 2010/0156604 A1
(43) Pub. Date: Jun. 24, 2010

(54) RFID TAG READING APPARATUS AND METHOD

(75) Inventor: Yanshi Dong, Shanghai (CN)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: General Electric Company, Schenectady, NY (US)

(21) Appl. No.: 12/340,786

(22) Filed: Dec. 22, 2008

(51) Int. Cl. H04Q 5/22

(52) U.S. Cl. 340/10.3

(57) ABSTRACT

A method comprises identifying a known-ID-number set comprising at least two ID numbers of corresponding tags and each ID number comprises a plurality of bit positions; calculating an entropy between each corresponding bit position in the known-ID-number set; identifying the bit position having a greatest entropy; and transmitting a reading query to the tags in a communication range. The reading query includes a differential specific number corresponding to the bit position having the greatest entropy.

### BACKGROUND

Embodiments of the invention are generally related to the field of Radio Frequency Identification (RFID), and more particularly, to an RFID tag reading apparatus and method.

RFID systems are used for a wide variety of purposes including to detect and prevent inventory shrinkage and to perform inventory management functions in a variety of retail establishments, such as apparel and mass merchandisers, supermarkets, libraries, video stores, and the like. In general, such systems use a tag which is associated with an article or packaging for the article. Each tag typically includes an integrated circuit and typically responds to, and transmits signals in a radio frequency range, to a transmitter or an interrogator. Accordingly, potential customers or facility users can find an article equipped with an RFID tag by using an interrogator.

If the interrogator has prior knowledge of an identification (ID) number of the tag associated with an article the interrogator is searching for, it can transmit a specific query to the article with that specific identification number. However, such a specific ID number is not always available. If there are multiple tags within the radio frequency range of the interrogator, then all tags may send their ID numbers to the interrogator at the same time in response to a non-specific query. This causes collisions and often results in no tag being identified.

Some efforts have been made to decrease the collision problem described above. U.S. Pat. Application Publication No. 2007/0096877, and U.S. Pat. No. 6,226,300 respectively describe RFID searching methods by an Aloga algorithm and a Tree algorithm. These algorithms generally assume that the ID numbers of the tags in a radio frequency range are independent and substantially evenly distributed. However, this is not true in many circumstances of RFID applications. For example, in warehouses, many of the same kind of products or articles have tags with ID numbers that differ only slightly from one another. During the interrogation cycle, this can still cause many collisions using the Aloga and tree algorithms. Accordingly, there is a need in the art to increase the RFID searching speed.

### BRIEF DESCRIPTION

In accordance with an embodiment disclosed herein, a method comprises identifying a known-ID-number set comprising at least two ID numbers of corresponding tags and each ID number comprises a plurality of bit positions; calculating an entropy between each corresponding bit position in the known-ID-number set; identifying the bit position having a greatest entropy; and transmitting a reading query to the tags in a communication range. The reading query includes a differential specific number corresponding to the bit position having the greatest entropy.

In accordance with another embodiment disclosed herein, an apparatus comprises a memory to store identification numbers of tags, and a processor. The processor is configured for identifying a known-ID-number set comprising at least two ID numbers of corresponding tags; calculating an entropy between each corresponding bit position of the at least two ID numbers in the known-ID-number set; identifying the bit position having a greatest entropy; and transmitting a reading query to the tags in a communication range. The reading query includes a differential specific number corresponding to the bit position having the greatest entropy.

In accordance with still another embodiment disclosed herein, a storage medium comprises a plurality of instructions. The storage medium, which when executed, cause an interrogator to: identify a known-ID-number set comprising at least two ID numbers of corresponding tags; calculate an entropy between each corresponding bit position in the known-ID-number set; identify the bit position having a greatest entropy; and transmit a reading query to the tags in a communication range, the reading query including a differential specific number corresponding to the bit position having the greatest entropy.

### DRAWINGS

These and other features, aspects, and advantages of the present invention will become better understood when the following detailed description is read with reference to the accompanying drawings in which like characters represent like parts throughout the drawings, wherein:

FIG. 1 illustrates an exemplary Radio Frequency Identification (RFID) system.

FIG. 2 is an exemplary process map of a method for searching a plurality of tags of the RFID system in FIG. 1, in accordance with one embodiment of the invention.

FIG. 3 illustrates an exemplary tree splitting searching process for identifying at least two ID numbers of two tags.

FIG. 4 is a diagramatic illustration of the searching process of FIG. 2.

FIG. 5 illustrates a more detailed view of an interrogator and an RFID tag, according to one embodiment.

### DETAILED DESCRIPTION

Embodiments of the description relate to a wireless identification system. The wireless identification system includes an apparatus or interrogator, and a plurality of tags within a communication range of the interrogator. The communication range may be limited by signal strength (e.g., of the interrogator) which affects the distance from which a tag may be separated from the interrogator. Similarly, the communication range may be limited or restricted to a particular operational frequency range of the interrogator. Each tag is encoded with a unique identification (ID) number, and is associated with one article. The interrogator transmits reading queries to the tags to identify the ID numbers of each tag in the communication range. In certain embodiments, if one reading query matches one unique ID number of one tag, the tag sends the ID number to the interrogator, and this ID number is identified by the interrogator. However, if one reading query matches a plurality of ID numbers of a plurality of tags, a search process that utilizes similarities of the ID numbers is employed to address collisions that might otherwise delay the tag identification process. In certain embodiments, the tags only communicate with the interrogator responsive to the reading queries from the interrogator.

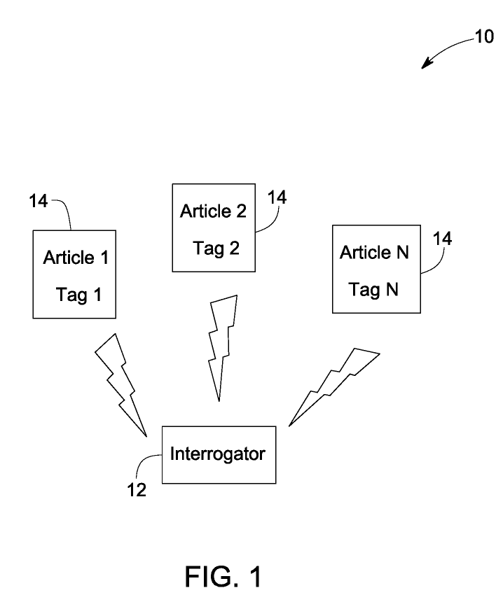

FIG. 1 illustrates an exemplary wireless identification system 10 including an interrogator 12 and a plurality of tags 14. Each tag 14 is associated with a corresponding article (not shown). In the illustrated embodiment, the wireless identification system 10 is a Radio Frequency Identification (RFID) system, and the tags 14 operate within a compatible radio frequency range of the interrogator 12. In one embodiment, a radio frequency range of the interrogator 12 may range from 300 to 3,000 MHz, also known as UHF frequencies.

Each tag 14 may be described as having a unique identification (ID) number ω, with each ID number ω being described by a string of digits b, (e.g., ω={b₁ b₂ b₃ . . . bᵢ . . . bₙ}). In one embodiment, each of the digits “bᵢ” represents a binary number having a value of “0” or “1”. In other embodiments, the digits may represent decimal, hexadecimal, or other mathematical numeral systems.

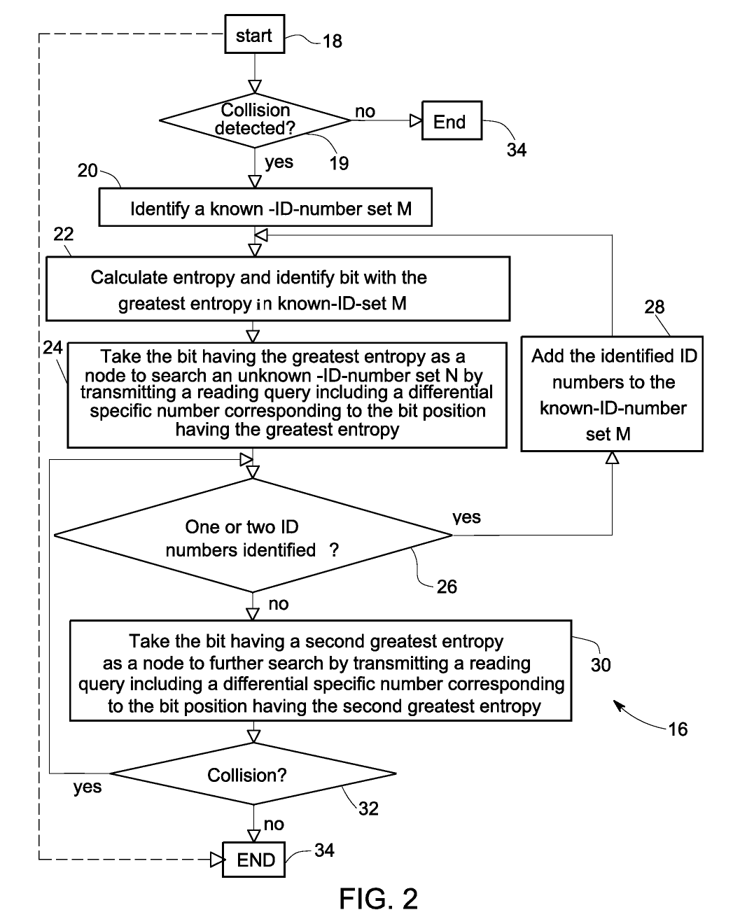

FIG. 2 is an exemplary process map of a searching process 16 for identifying the tags 14 in accordance with one embodiment of the invention. In the illustrated embodiment, the searching process utilizes similarities of the ID numbers of the tags 14 in the communication range of the interrogator 12 in order to avoid collisions.

The exemplary searching process 16 starts at step 18. In one embodiment, the interrogator 12 sends a masked “start reading” query for addressing all tags 14 in the communication range of the interrogator 12. In one embodiment, the start reading query includes a bit mask that masks all but a chosen (e.g., pre-selected or randomly selected) bit location. That chosen bit location may be programmed to identify a desired value such as “0” or “1” in a binary system.

At step 19, in the illustrated embodiment, the interrogator 12 may decide if a collision is detected. If the interrogator 12 successfully reads only one ID number ω, it is assumed that only one associated tag 14 is in the communication range of the interrogator 12. As such, the single tag 14 is identified, and the searching process 16 ends at a step 34. If the interrogator 12 receives no response, it is assumed that no tags 14 are in the communication range of the interrogator 12, and again the search process 16 ends at step 34. If interrogator 12 receives responses from the query but can not successfully read any ID number, a collision is detected and the searching process 16 proceeds with step 20.

In certain embodiments, the exemplary searching process 16 comprises setting a known-ID-number set M at step 20. The known-ID-number set M includes at least two ID numbers ω1 and ω2 of two corresponding tags 14. In one embodiment, the at least two ID numbers ω1 and ω2 have been previously identified and are considered prior knowledge of the RFID system 10. In an alternative embodiment, the two ID numbers ω1 and ω2 may be identified by any possible RFID identification method. In one embodiment a tree splitting search process may be used for identifying two or more ID numbers to set up the known-ID-number set M.

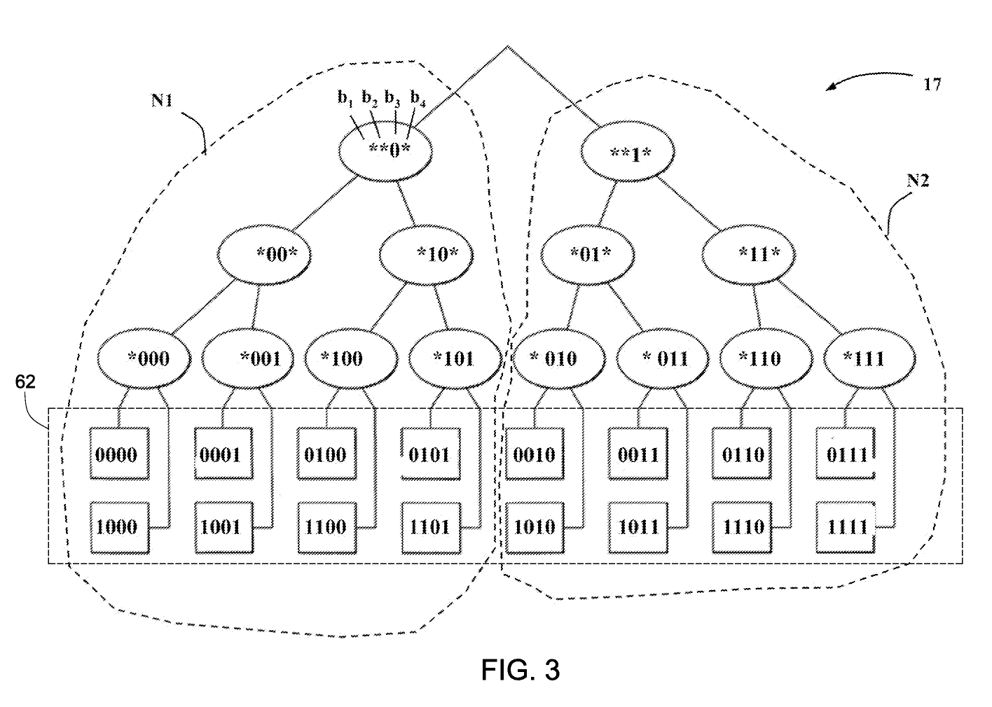

Referring now to FIG. 3, a tree splitting search process for identifying two or more known ID numbers is shown. The exemplary search process 17 of FIG. 3 includes the interrogator 12 sending a reading query with a differential specific number at one randomly or pre-selected bit position to split all tags into two groups. A “differential specific number” hereinafter refers to a definite bit value or values such as, for example, either “0” or “1” which can differentiate the ID number against other ID numbers having other bit values at the correspondingly selected bit position(s). It should be noted that the bit-length of the tags and the bit position selected for screening may vary depending upon implementation. In the illustrated example, tags with bit-lengths of four are illustrated and the bit position is referenced from left-to-right as b₁, b₂, b₃ and b₄. This is for ease of description and in practice, the bit-lengths may be much longer. As illustrated, the interrogator 12 may select bit position three (e.g., b₃) as a first splitting node and send a reading query to the tags 14 with all bit positions except the third being masked (e.g., “**0*” and “**1*”, where “*” represents a masked bit). The tags 14 are then split into two groups N1 and N2, with one group N1 comprising tags with ID numbers having a first value (e.g., “0”) in the selected bit position (e.g., b₃), and the second group N2 comprising tags with ID numbers having a second value (e.g., “1”) at the same bit position. Each of the two groups N1 and N2 are further split into two sub-groups by randomly selecting a second splitting node at bit position two (e.g. b₂) and transmitting a reading query to the tags with b₂ having a differential specific number. The subgroups are further divided, until two or more ID numbers are identified as the ID numbers shown in the dotted-line block 62, and thereafter made members of the known-ID-number set M. It should be understood the at least two ID numbers for the known-ID-number set M may be identified by any possible RFID identification method, and need not be limited to the search scheme of FIG. 3.

Referring back to FIG. 2, at step 22, an entropy is calculated between each corresponding bit position of the at least two ID numbers in the known-ID-number set M. Interrogator 12 then compares the entropies of the bit positions and determines the bit position having the greatest entropy.

As used herein, “entropy” of one bit position is a measurement of the level of variability between corresponding bit positions among the identified ID numbers in the known-ID-number set M. A high entropy means that the ID numbers of set M have a large variability with respect to corresponding bit positions, and a low entropy means that the ID numbers of set M have a small variability with respect to corresponding bit positions. In one embodiment, an entropy H(i) of one bit position can be calculated by equation 1:

$$H ( i ) = - {\sum }_{j = 0}^{1} \frac{\vert \{ ω \text{:} ω ∈ M \vert {ω}_{i} = j \} \vert}{\vert M \vert} log ( \frac{\vert \{ ω \text{:} ω ∈ M \vert {ω}_{i} = j \} \vert}{\vert M \vert} ) \qquad equation 1$$

wherein ω is an ID number of a tag 14.

The entropies for each bit position are calculated and compared to determine the greatest entropy Hₕ at a bit position bₕ.

Still referring to FIG. 2, at step 24, bit position bₕ that has been determined to have the greatest entropy Hₕ is taken as a node to perform a search for identifying ID numbers of an unknown-ID-number set N. The interrogator sends a differential specific number at the bit position bₕ.

In one embodiment, the interrogator 12 sends a reading query with a first value (e.g., “1”) at the bit position bₕ and mask bits at the other bit positions, as well as a reading query with a second value (e.g., “0”) at the bit position bₕ and mask bits at the other bit positions. By doing so, the tags 14 in the unknown-ID-number set N are divided into a first and a second group, with the first group having the first value (e.g., with “1”) at the bit position bₕ and the second group having the second value (e.g., “0”) at the bit position bₕ. In certain embodiments, if only one ID number contains the indicated value at the bit position bₕ, the corresponding tag 14 will send a message with the ID number to the interrogator 12 in response to the reading query with that particular value at the bit position bₕ. For example, if only one ID number of the unknown-ID-number set N has “0” at the bit position bₕ, this ID number can be identified by the interrogator 12. Similarly, if only one ID number of the unknown-ID-number set N has “1” at the bit position bₕ, this ID number can be identified by the interrogator 12. If two or more ID numbers of the unknown-ID-number set has the requested value at the bit bₕ, the interrogator 12 detects a collision.

At step 26, the interrogator 12 determines if one or two ID numbers are identified at step 24. If one or two ID numbers are identified, the ID numbers are added to the known-ID-number set M at step 28. The searching process 16 returns back to step 22, and updated entropies of bit positions are calculated based on the updated known-ID-number set M, and an updated greatest entropy is calculated based on the updated known-ID-number. Steps 22-26 are repeated until all ID numbers in the communication range of the interrogator are identified.

At step 26, if the interrogator 12 determines that no ID number is identified at step 24, the interrogator 12 detects a collision, and the searching process 16 proceeds with step 30.

At step 30, a bit position bₛ having a second greatest entropy Hₛ, according to the calculation at step 22, is taken as a second splitting node to further identify the ID numbers in the unknown-ID-number set N. The interrogator 12 sends a differential specific number at the bit position bₛ, and each of the first and second groups N1 and N2 is differentiated into two sub-groups.

At step 32, the interrogator 12 determines if a collision occurs after step 30. If no collision occurs, all ID numbers are identified, and the searching process 16 ends at step 34. If a collision occurs, the search process 16 returns back and repeats at step 26 until all ID numbers in the communication range of the interrogator 12 are identified.

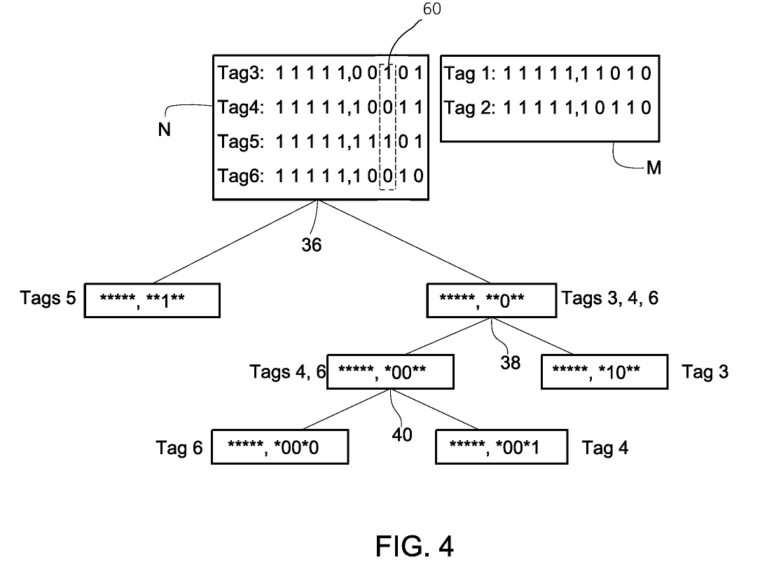

FIG. 4 shows an example of the search process 16 for establishing communications between the interrogator 12 and a plurality of tags 14 within a radio frequency range of the interrogator 12. Referring to FIG. 4, the tags 14 includes a known-ID-number set M having Tags 1 and 2, and an unknown-ID-number set N having Tags 3-6. The known-ID-number set M may have been previously identified by the interrogator 12, or may be identified by any possible identification methods.

In the example in FIG. 4, for simplicity each ID number of the tags 1-6 includes a numerical string represented only by 10 bits. However, in real application, each ID number of the tags will generally comprise a large number of bits, for example 96 or 120 bits.

The interrogator 12 calculates entropies of each corresponding bit position of ID numbers of tags in the known-ID-number set M according to equation 1. In the illustrated example, these are represented by Tags 1 and 2.

In the illustrated example, the entropies of bit positions 7 and 8 of Tags 1 and 2 are identified as having the greatest entropies. Accordingly, the interrogator 12 selects bit position 8, as shown in phantom block 60 of FIG. 4, as a first splitting node 36, and sends a reading query “*****, **1**” and a reading query “*****, **0**” to Tags 3-6, wherein “*” is a mask number that represents either 0 or 1. Then Tags 3, 4 and 6 respond to the reading query “*****, **0**” and a collision occurs. Tag 5 is the only tag to respond to the reading query “*****, **1**” and thus tag 5 is identified, and the ID number of Tag 5 is added to the known-ID-number set M.

The interrogator 12 then calculates entropies of each bit position based on the ID numbers of Tags 1, 2 and 5 now in the known-ID-number set M. Bit numbers 7, 8, 9 and 10 are determined to have equally the greatest entropies. For the purpose of example, bit position 7 is taken as a second node 38 for further reading of tags 3, 4 and 6. The interrogator 12 sends a reading query “*****, *00**” and a reading query “*****, *10**” to Tags 3, 4 and 6. Tag 3 responds to the reading query “*****, *10**”, and thus the ID number of Tag 3 is identified and is added to the known-ID-number set M. Tags 4 and 6 respond to “*****, *00**”, and a further collision is detected.

Once again, the interrogator 12 calculates entropies of each corresponding bit position of the ID numbers in the known-ID-number set M, this time Tags 1, 2, 3 and 5. Bit numbers 7, 9 and 10 have equally greatest entropies. For the purpose of example, bit position number 10 is taken as a third node 40 for identifying tags 4 and 6. The interrogator 12 sends reading queries “*****, *00*0”, and “*****, *00*1” to Tags 4 and 6. Tags 4 and 6 respond to “*****, *00*1” and “*****, *00*0”, respectively and thus both are identified. Since no additional tags remain in the unknown-ID-number set N, the search process ends.

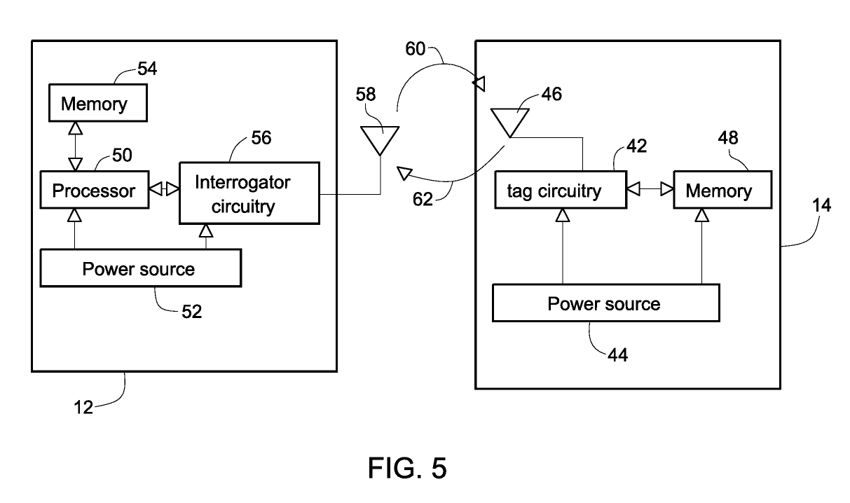

FIG. 5 illustrates a more detailed view of an interrogator and an RFID tag, according to one embodiment. Referring to FIG. 5, each tag 14 includes a tag circuitry 42, and a power source 44 coupled to the tag circuitry 42 to supply power to the tag circuitry 42. In one embodiment, the power source 44 may include a battery. Each tag 14 further includes at least one antenna 46 connected to the tag circuitry 42 for wireless or radio frequency transmission and reception by the tag circuitry 42. In one embodiment, the tag 14 further includes a memory 48, coupled to the tag circuitry 42, for storing data, such as an ID number, a name of the article, location of the article or other identifying information.

In one embodiment, the interrogator 12 includes a CPU or a processor 50, a power source 52, a memory 54 for storing identified ID numbers of tags 14, an interrogator circuitry 56, and an antenna 58. The power source 52 supplies direct-current power to the processor 50 and the interrogator circuitry 56. In one embodiment, the processor 50 stores instructions to cause the interrogator 12 to identify a known-ID-number set comprising at least two ID numbers of corresponding RFID tags; calculate an entropy between each corresponding bit position in the known-ID-number set; identify the bit position having a greatest entropy; and transmit a reading query to the tags in a radio frequency range, the reading query including a differential specific number corresponding to the bit position having the greatest entropy.

In one embodiment, the interrogator 12 transmits a reading query 60 via the antenna 58. The tag 14 receives a reading query 60 via its antenna 46. Upon receiving the reading query 60, the tag 14 responds by generating and transmitting a responsive signal or reply 62. The responsive signal 62 includes the ID number of the tag 14.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method comprising:
identifying a known-ID-number set comprising at least two ID numbers of corresponding tags, where each ID number comprises a plurality of bit positions;
calculating an entropy between each corresponding bit position in the known-ID-number set;
identifying the bit position having a greatest entropy; and
transmitting a reading query to the tags in a communication range, the reading query including a differential specific number corresponding to the bit position having the greatest entropy.

2. The method according to claim 1, wherein transmitting a reading query to the tags in a communication range comprises transmitting the reading query with either “0” or “1” corresponding to the bit position having the greatest entropy.

3. The method according to claim 2, wherein transmitting a reading query to the tags in a communication range comprises transmitting a first reading query with “0” at the bit position having the greatest entropy and masks in other bit positions, and a second reading query with “1” at the bit position having the greatest entropy and masks in other bit positions, a mask representing either “0” or “1”.

4. The method according to claim 1 further comprising identifying a bit position having a second greatest entropy, and transmitting a reading query to the tags in a communication range, the reading query including a differential specific number corresponding to the bit position having the second greatest entropy.

5. The method according to claim 4 further comprising sending a reading query including a differential specific number corresponding to the a bit position having a second greatest entropy when no ID number is identified.

6. The method according to claim 1 further comprising adding ID numbers identified to the known-ID-number set to get an updated known-ID-number set, and calculating an updated entropy between each corresponding bit position in the updated known-ID-number set.

7. The method according to claim 1, wherein said at least two ID numbers are prior knowledge of the tags.

8. The method according to claim 1, wherein the step of identifying at least two IDs of two corresponding tags being conducted by any possible identification method.

9. An apparatus comprising:
a memory to store identification numbers of tags; and
a processor for:
identifying a known-ID-number set comprising at least two ID numbers of corresponding tags;
calculating an entropy between each corresponding bit position of the at least two ID numbers in the known-ID-number set;
identifying the bit position having a greatest entropy; and
transmitting a reading query to the tags in a communication range, the reading query including a differential specific number corresponding to the bit position having the greatest entropy.

10. The apparatus according to claim 9, wherein the processor is configured to transmit the reading query with either “0” or “1” corresponding to the bit position having the greatest entropy.

11. The apparatus according to claim 10, wherein the processor is configured to transmit a first reading query with “0” at the bit position having the greatest entropy and bit masks in other bit positions, and to transmit a second reading query with “1” at the bit position having the greatest entropy and bit masks in other bit positions, wherein a bit mask representing either “0” or “1”.

12. The apparatus according to claim 9, wherein the processor is further configured to identify a bit position having a second greatest entropy, and transmit a reading query to the tags in a communication range, the reading query including a differential specific number corresponding to the bit position having the second greatest entropy.

13. The apparatus according to claim 12, wherein the processor is further configured to send a reading query including a differential specific number corresponding to the a bit position having a second greatest entropy when no ID number is identified.

14. The apparatus according to claim 9, wherein the processor is further configured to add ID numbers identified to the known-ID-number set to obtain an updated known-ID-number set, and calculate an updated entropy between each corresponding bit position in the updated known-ID-number set.

15. A storage medium comprising a plurality of instructions, which when executed, cause an interrogator to:
identify a known-ID-number set comprising at least two ID numbers of corresponding tags;
calculate an entropy between each corresponding bit position in the known-ID-number set;
identify the bit position having a greatest entropy; and
transmit a reading query to the tags in a communication range, the reading query including a differential specific number corresponding to the bit position having the greatest entropy.
